(19) United States
(12) Patent Application Publication
(10) Pub. No.: US 2017/0340957 A1
(43) Pub. Date: Nov. 30, 2017

(54) CROSS PLATFORM CONTROLLER

(71) Applicant: Jesse Cochenour, Austin, IN (US)

(72) Inventor: Jesse Cochenour, Austin, IN (US)

(21) Appl. No.: 15/162,722

(22) Filed: May 24, 2016

(51) Int. Cl. A63F 13/215; A63F 13/24

(52) U.S. Cl. CPC A63F 13/215; A63F 13/24

(57) ABSTRACT

A gaming controller that includes: a left analog controller on a face of the controller; a right analog controller on the face of the controller; a speaker at the center of the controller; a microphone on the face of the controller; and mechanisms to enable cross platform integration of the controller. The gaming controller may further include a speaker and directional control buttons on the face of the controller. In another exemplary embodiment, the gaming controller includes voice control aspects, and a power button and a select button on the face of the controller.

### BACKGROUND OF THE INVENTION

### Field of Invention

The present invention relates to a cross platform game controller that enables the user to use a single controller across various gaming platforms.

### Description of Related Art

Video gaming is a large industry throughout the world. Typically, users engage in video games through various gaming platforms. Gaming consoles may connect to the Internet, computers and entertainment systems to engage in the gaming experience. The detailed video game platform includes a game controller that is used by participants to control the action, selection, power features and other aspects of the gaming experience. However different gaming platforms such as the Xbox or PlayStation have different controllers with the basic features however cannot be used in opposing platforms. As a result, it would be advantageous to have a universal gaming controller that could be used across gaming platforms without the need to have separate controllers for each gaming platform.

### SUMMARY OF THE INVENTION

The present invention relates to a gaming controller that includes: a left analog controller on a face of the controller; a right analog controller on the face of the controller; a speaker at the center of the controller; a microphone on the face of the controller; and mechanisms to enable cross platform integration of the controller. The gaming controller may further include a speaker and directional control buttons on the face of the controller. In another exemplary embodiment, the gaming controller includes voice control aspects, and a power button and a select button on the face of the controller.

### BRIEF DESCRIPTION OF DRAWINGS

FIG. 1 depicts a cross platform gaming controller in accordance with the present invention.

### DETAILED DESCRIPTION

The present invention relates to a cross platform gaming controller that enables the user to use a single controller across opposing gaming platforms. The gaming platform controller according to the present invention has a universal design with controlling directional buttons, action buttons and analog movement buttons. In addition, the present invention includes speakers and microphones implemented within the gaming controller so that the controller has additional gaming features. Further, the gaming controller includes vibrating effects similar to the existing controllers used on existing gaming platforms.

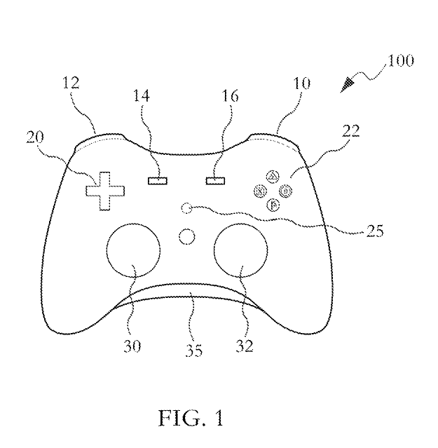

In reference to FIG. 1, a top view of game controller 100 according to the present invention is depicted. The gaming controller according to the present invention includes a left analog controller 30 and a right analog controller 32 centered along the face of the game controller 100. In addition, along the back surface of the controller or a near surface to a user, a speaker 35 is positioned. In addition to the speaker 35, a microphone 25 is implemented at the center of the controller 100. The microphone 25 provides an opportunity for implementation of voice control aspects associated with the gaming controller 100. Directional control button 20 is shown at the upper left side of the controller 100 and at the right upper corner are action buttons 22. Further control buttons along the top surface include a power button 16 and a select button 14. Through the use of this configuration, a user may execute action and interaction with the gaming platform. This particular controller according to the present invention is capable of functioning across gaming platforms and is therefore compatible with multiple gaming formats. The controller 100 is wireless and transmits control signals through conventional wireless connectivity associated with gaming controllers. As a result, a gaming user uses a single gaming controller when operating games on consoles such as PlayStation or Xbox without the need for additional controllers for the multiple gaming platforms. The instant invention has been shown and described in what it considers to be the most practical and preferred embodiments. It is recognized, however, that departures may be made there from within the scope of the invention and that obvious modifications will occur to a person skilled in the art.

What is claimed is:

1. A gaming controller comprising:
a. a left analog controller on a face of the controller;
b. a right analog controller on the face of the controller;
c. a speaker at the center of the controller;
d. a microphone on the face of the controller; and
e. mechanisms to enable cross platform integration of the controller.

2. The gaming controller according to claim 1, further including a speaker.

3. The gaming controller according to claim 1, further including directional control buttons on the face of the controller.

4. The gaming controller according to claim 1, further including voice control aspects.

5. The gaming controller according to claim 1, further including a power button and a select button on the face of the controller.
